(19) United States
(12) Patent Application Publication
(10) Pub. No.: US 2008/0219609 A1
(43) Pub. Date: Sep. 11, 2008

(54) Bicycle treadle bearing assembly

(76) Inventor: Kun-Yuan Li, Taichung Hsien (TW)

Correspondence Address: KUN-YUAN LI, 235 Chung - Ho, Box 8-24, Taipei, TW

(21) Appl. No.: 11/714,240

(22) Filed: Mar. 6, 2007

(51) Int. Cl. F16C 9/02

(52) U.S. Cl. 384/458

(57) ABSTRACT

A bicycle treadle bearing assembly comprises a seat being a concave receiving portion at an upper portion thereof; a lower portion of the seat being a thread portion; a bearing; a periphery of the bearing being formed with a plurality of axially arranged rolling posts each of which is rotatably axially; a supporting casing arranged around the bearing; an inner surface of the supporting casing being corresponding to that of an outer surface of the bearing. In assembly, the supporting casing encloses the bearing therein and then the supporting casing and the bearing are placed into the receiving portion. The bearing has a tapered outer surface and an inner surface of the supporting casing is a tapered surface corresponding to the outer surface of the bearing. A cover is installed upon the supporting casing and the bearing so as to seal the bearing and the supporting casing therein.

### FIELD OF THE INVENTION

The present invention relates to bicycle bearings, and particularly to a bicycle treadle bearing assembly, wherein a plurality of rolling posts of the bearing are provided with more contact areas to the supporting casing so that the stress from the treading force of the user can be distributed effectively. The bearing and supporting casing are completely sealed within the receiving portion of the seat so that dust will not pollute the bearing and the supporting casing.

### BACKGROUND OF THE INVENTION

The prior art bicycle treadle bearing assembly has a bowl body, a steel ball ring and a positioning cover. The bowl body has a seat for receiving the steel ball ring therein. An inner wall of the seat is formed with an embedding groove. An outer edge of the cover is formed with an embedding edge which is engaged to the embedding groove.

However in the prior art, the steel balls are point-contact with the seat so that the force suffered is small. In treading, the force is transferred from the crank to the bearing. All the force is applied to the steel balls. Thus the prior art design makes the bearing easily destroyed or deform. In some improvements, greater bearings are used for enhancing the strength, but this will cause that the size of the spindle of the bicycle must be reduced. However the reduction of the size of the spindle will make the supporting force being reduced and thus the whole structural strength of the treading assembly of the bicycle is weakened.

### SUMMARY OF THE INVENTION

Accordingly, the primary object of the present invention is to provide a bicycle treadle bearing assembly, wherein a plurality of rolling posts of the bearing are provided more contact area with respect to the supporting casing so that the stress from the treading force of the user can be distributed effectively. The bearing and supporting casing are completely sealed within the receiving portion of the seat so that dust will not pollute the bearing and the supporting casing.

To achieve above objects, the present invention provides a bicycle treadle bearing assembly comprising: a seat being a concave receiving portion at an upper portion thereof; a lower portion of the seat being a thread portion which have threads at an outer surface thereof for engaging with a spindle of a bicycle; a bearing; a periphery of the bearing being formed with a plurality of axially arranged rolling posts each of which is rotatably axially; a supporting casing arranged around the bearing; a inner surface of the supporting casing being corresponding to that of an outer surface of the bearing so as to enclose the bearing therein. In assembly, the supporting casing encloses the bearing therein and then the supporting casing and the bearing are placed into the receiving portion of the seat. The bearing has a tapered outer surface and an inner surface of the supporting casing is a tapered surface corresponding to the outer surface of the bearing. The bearing has a great upper side and a small lower side or the bearing has a small upper side and a great lower side. Furthermore, a cover is installed upon the supporting casing and the bearing so as to seal the bearing and the supporting casing in the receiving portion without exposing out.

The various objects and advantages of the present invention will be more readily understood from the following detailed description when read in conjunction with the appended drawing.

### BRIEF DESCRIPTION OF THE DRAWINGS

FIG. 1 is an explosive schematic view of the bicycle treadle bearing assembly of the present invention.

FIG. 2 is an assembled schematic view of the bicycle treadle bearing assembly of the present invention.

FIG. 3 is a schematic cross sectional view along line AB of FIG. 2.

FIG. 4 is a schematic view showing the application of the bicycle treadle bearing assembly of the present invention.

FIG. 5 is a schematic cross sectional view about another embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

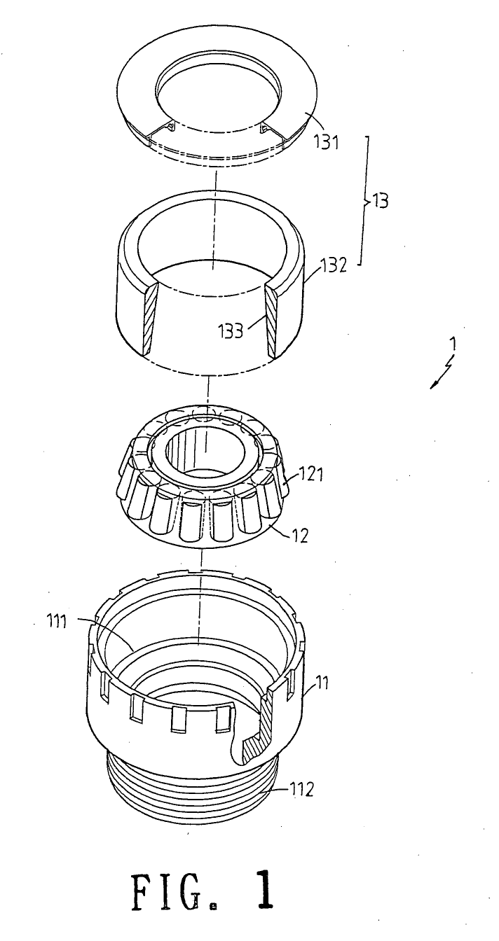

Referring to FIGS. 1 to 3, the bicycle treadle bearing assembly of the present invention is illustrated. The bicycle treadle bearing assembly 1 has the following elements.

A seat 11 is a concave receiving portion 111 at an upper portion thereof. A lower portion of the seat 11 is a thread portion 112 which have threads at an outer surface thereof for engaging with a spindle of a bicycle.

A bearing 12 has a tapered shape with a larger lower side and a small upper side. A periphery of the bearing 12 is formed with a plurality of axially arranged rolling posts 121 each of which is rotatably axially.

A supporting casing 13 is arranged around the bearing 12. An inner surface of the supporting casing 13 is an inclined inner surface 133 which is a tapered surface with an inclination corresponding to that of the outer surface of the bearing 12 so as to enclose the bearing 12 therein.

A cover 131 covers upon upper sides of the supporting casing 13 and the bearing 12.

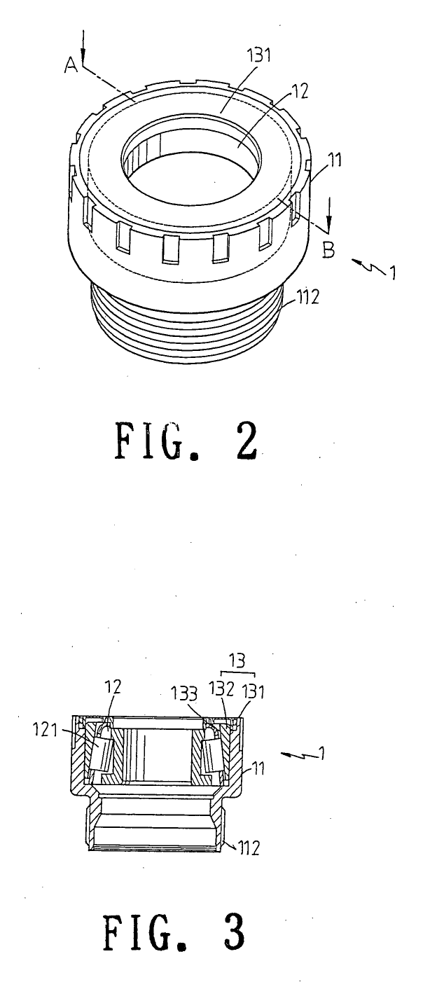

Referring to FIGS. 2 and 3, in assembly, the supporting casing 13 encloses the bearing 12 therein and then the supporting casing 13 and the bearing 12 are placed into the receiving portion 111 of the seat 11. Then the cover 131 is installed upon the supporting casing 13 and the bearing 12 so as to seal the bearing 12 and the supporting casing 13 in the receiving portion 111 without exposing out.

Advantage of the present invention is that the rolling posts 121 provide more contact area with respect to the supporting casing 13 so that the stress from the treading force of the user can be distributed effectively. Thereby the inclination of the tapered bearing 12 can reduce the wearing for long period usage of the bearing assembly. Moreover, in the present invention, the bearing 12 and supporting casing 13 are completely sealed within the receiving portion 111 of the seat 111 so that dust will not pollute the bearing 12 and the supporting casing 13.

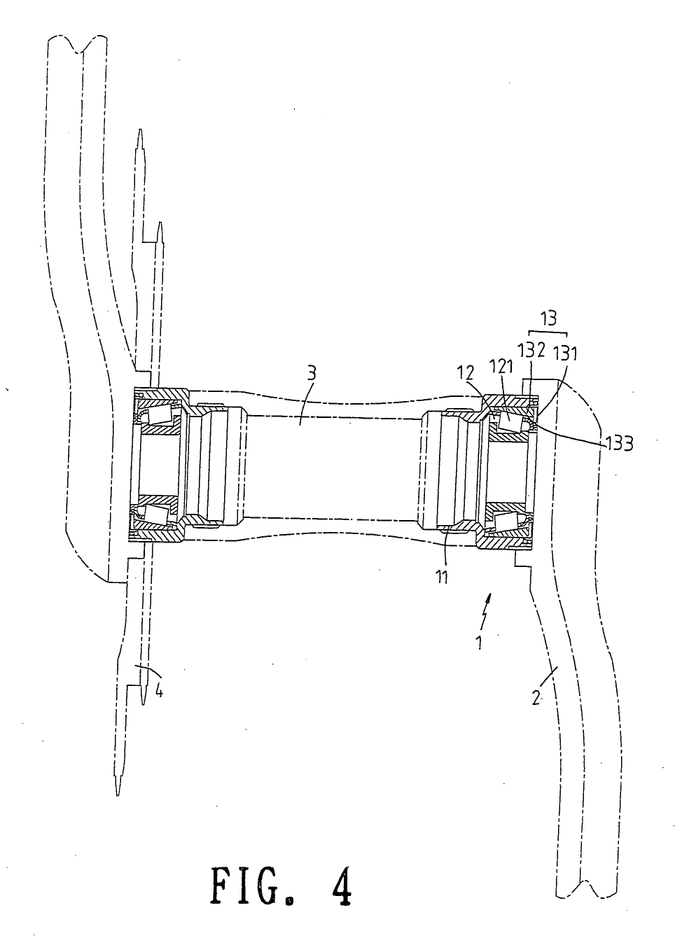

Referring to FIG. 4, it is illustrated that the body 1 of the present invention is installed to two ends of a spindle 3 of a bicycle. The thread portion 112 of the seat 11 is engaged to the spindle 3. The bearing 12 is engaged to a crank 2 of the bicycle. One end of the spindle 3 is installed with a gear 4. In treading as the user drives the bicycle, the body 1 will rotate with the crank 2 is as an axial center. In the present invention, by the design of the rolling posts 121, the stress is applied to the whole bearing surface so that it can suffer from a greater stress. Thus the length of the crank 2 can be increased and thus a great twisting force can be applied thereto. Moreover, the designs of the tapered bearing 12 with a plurality of inclined rolling posts 121 and the inclined inner surface 133 of the supporting casing 13 are helpful to have great contact areas. The stress will not concentrate to some predetermined area, but is distributed in the whole outer surface. Thus the deformation and wearing from treading operation are reduced greatly.

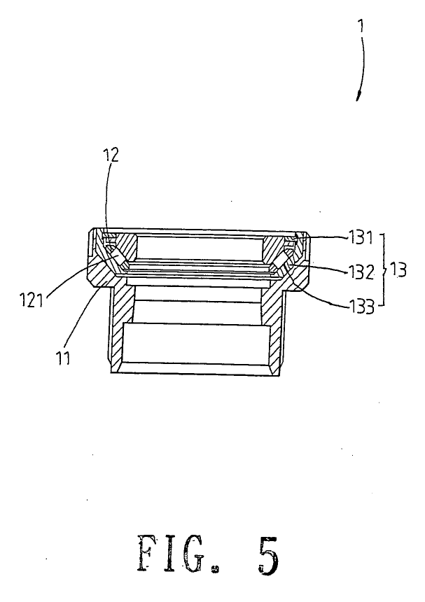

Referring to FIG. 5, another embodiment of the present invention is illustrated. In this embodiment, those identical to the above embodiment will not be further described herein. Only those different from above embodiment are described. The difference of the present invention from the first embodiment is that in the present invention, the tapered bearing 12 has a great upper side and a small lower side and the inclined inner surface 133 of the supporting casing 13 has a great upper side and a small lower side which are corresponding to that of the bearing 12. However this design can achieve the same effect as the former one.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A bicycle treadle bearing assembly comprising:
a seat being a concave receiving portion at an upper portion thereof; a lower portion of the seat being a thread portion which have threads at an outer surface thereof for engaging with a spindle of a bicycle;
a bearing; a periphery of the bearing being formed with a plurality of axially arranged rolling posts each of which is rotatably axially;
a supporting casing arranged around the bearing; an inner surface of the supporting casing being corresponding to that of an outer surface of the bearing so as to enclose the bearing therein; and
wherein in assembly, the supporting casing encloses the bearing therein and then the supporting casing and the bearing are placed into the receiving portion of the seat.

2. The bicycle treadle bearing assembly as claimed in claim 1, wherein the bearing has a tapered outer surface and an inner surface of the supporting casing is a tapered surface corresponding to the outer surface of the bearing.

3. The bicycle treadle bearing assembly as claimed in claim 2, wherein the bearing has a great upper side and a small lower side.

4. The bicycle treadle bearing assembly as claimed in claim 2, wherein the bearing has a small upper side and a great lower side.

5. The bicycle treadle bearing assembly as claimed in claim 1, wherein a cover is installed upon the supporting casing and the bearing so as to seal the bearing and the supporting casing in the receiving portion without exposing out.
